(19) United States
(12) Patent Application Publication
(10) Pub. No.: US 2018/0354713 A1
(43) Pub. Date: Dec. 13, 2018

(54) BEVERAGE CARTRIDGE AUTHENTICATION

(71) Applicant: SharkNinja Operating LLC, Needham, MA (US)

(72) Inventors: Michael Ting, Boston, MA (US); Ross Richardson, Dover, MA (US); Allan Neville, Milton, MA (US); Jared J. Proulx, Needham, MA (US); John Benoit, Everett, MA (US); Ethan Brown, Cambridge, MA (US); Colden N. Eldridge, Allston, MA (US)

(21) Appl. No.: 16/001,587

(22) Filed: Jun. 6, 2018

Related U.S. Application Data
(60) Provisional application No. 62/516,360, filed on Jun. 7, 2017.

(51) Int. Cl. B65D 85/804; A47J 31/40; A47J 31/44

(52) U.S. Cl. CPC B65D 85/8043; A47J 31/4492; A47J 31/407

(57) ABSTRACT

A cartridge for use with a beverage brewing system to prepare a brewed beverage includes a cartridge body having a chamber and a flavorant arranged within the chamber. A first identification element is applied to the cartridge and provides a first cartridge authenticator. A second identification element is applied to the cartridge and provides a second cartridge authenticator.

### CROSS-REFERENCE TO RELATED APPLICATIONS

This application claims the benefit of U.S. Provisional Patent Application No. 62/516,360 filed Jun. 7, 2017, which is incorporated herein by reference in its entirety.

### BACKGROUND

Exemplary embodiments of the present disclosure relate to a cartridge for the preparation of a beverage such as in a beverage producing system, and more particularly, to a cartridge including an identification element for enabling detection of the cartridge by the beverage producing machine.

Beverage producing systems have been developed on the basis of portioned beverages, in particular, cartridges containing a predetermined dose of beverage ingredient such as coffee, tea, milk powder and the like. The advantages of such systems have been widely recognized. In particular, beverage producing systems using prepackaged cartridges are convenient to use, perform clean operations, and provide enhanced quality control of the brewed beverage delivered. Because of these advantages, cartridges are being launched onto the market in by several manufacturers and in abundant variety. Since these cartridges are often quite similar in appearance, it is possible that one manufacturer's capsules are used in a coffee machine designed by another manufacturer. This may result in significant security issues and/or the damage to the machine.

### SUMMARY

According to one embodiment, a cartridge for use with a beverage brewing system to prepare a brewed beverage includes a cartridge body having a chamber and a flavorant arranged within the chamber. A first identification element is applied to the cartridge and provides a first cartridge authenticator. A second identification element is applied to the cartridge and provides a second cartridge authenticator.

In addition to one or more of the features described above, or as an alternative, in further embodiments said first identification element and said second identification element are different.

In addition to one or more of the features described above, or as an alternative, in further embodiments said first identification element comprises data extending in two directions.

In addition to one or more of the features described above, or as an alternative, in further embodiments said first identification element includes a rastered graphic.

In addition to one or more of the features described above, or as an alternative, in further embodiments said rastered graphic includes at least one of a logo and trademark associated with a brand of the cartridge.

In addition to one or more of the features described above, or as an alternative, in further embodiments said first cartridge authenticator the cartridge includes determining a brand of the cartridge.

In addition to one or more of the features described above, or as an alternative, in further embodiments said first cartridge authenticator includes determining whether the cartridge is compatible for use with the beverage brewing system.

In addition to one or more of the features described above, or as an alternative, in further embodiments said second identification element includes one of a one dimensional code and a two dimensional code.

In addition to one or more of the features described above, or as an alternative, in further embodiments said second identification element includes a barcode.

In addition to one or more of the features described above, or as an alternative, in further embodiments said second identification element further comprises a first component and a second component, distinct from said first component. The first component and the second component contain different types of information.

In addition to one or more of the features described above, or as an alternative, in further embodiments said first component includes an identification code.

In addition to one or more of the features described above, or as an alternative, in further embodiments said first component is operable to provide said second cartridge authenticator.

In addition to one or more of the features described above, or as an alternative, in further embodiments said second cartridge authenticator includes determining whether the cartridge has been used previously.

In addition to one or more of the features described above, or as an alternative, in further embodiments said second component is associated with one or more parameters of a recipe for preparing a brewed beverage.

In addition to one or more of the features described above, or as an alternative, in further embodiments said second component includes a recipe look up code.

In addition to one or more of the features described above, or as an alternative, in further embodiments said first identification element and said second identification element are disposed at a first surface of said cartridge body.

In addition to one or more of the features described above, or as an alternative, in further embodiments said first identification element is located at a first surface of said cartridge body and said second identification element is arranged at a second surface of said cartridge body, said first surface being different from said second surface.

According to another embodiment, a method of preparing a brewed beverage using a cartridge includes scanning and processing a first identification element to perform a first authentication of the cartridge, scanning and processing a second identification element to perform a second authentication of the cartridge, and preparing the brewed beverage in response to said first authentication and said second authentication.

In addition to one or more of the features described above, or as an alternative, in further embodiments scanning and processing said first identification element includes determining a brand of the cartridge.

In addition to one or more of the features described above, or as an alternative, in further embodiments scanning and processing said first identification element includes determining whether the cartridge is compatible for use with the beverage brewing system.

In addition to one or more of the features described above, or as an alternative, in further embodiments scanning and processing said second identification element further comprises scanning and processing a first component of said second identification element to perform said second authentication and scanning and processing a second component of said second identification element to determine one or more parameters for preparing the brewed beverage.

In addition to one or more of the features described above, or as an alternative, in further embodiments scanning and processing said first component of second identification element includes determining whether the cartridge has been used previously.

In addition to one or more of the features described above, or as an alternative, in further embodiments scanning and processing said second component of second identification element includes identifying a recipe look up code associated with the cartridge.

### BRIEF DESCRIPTION OF THE FIGURES

The accompanying drawings incorporated in and forming a part of the specification embodies several aspects of the present disclosure and, together with the description, serves to explain the principles of the disclosure. In the drawings:

FIG. 1A is a perspective view of a cartridge for use with a beverage brewing system according to an embodiment;

FIG. 1B is a side view of a cartridge for use with a beverage brewing system according to an embodiment;

FIG. 1C is a cross-sectional view of a cartridge for use with a beverage brewing system according to an embodiment;

FIG. 2 is a detailed view of at least one identifier associated with the cartridge according to an embodiment; and

FIG. 3 is a schematic illustration of an example of a beverage brewing system.

The detailed description explains embodiments of the disclosure, together with advantages and features, by way of example with reference to the drawings.

### DETAILED DESCRIPTION

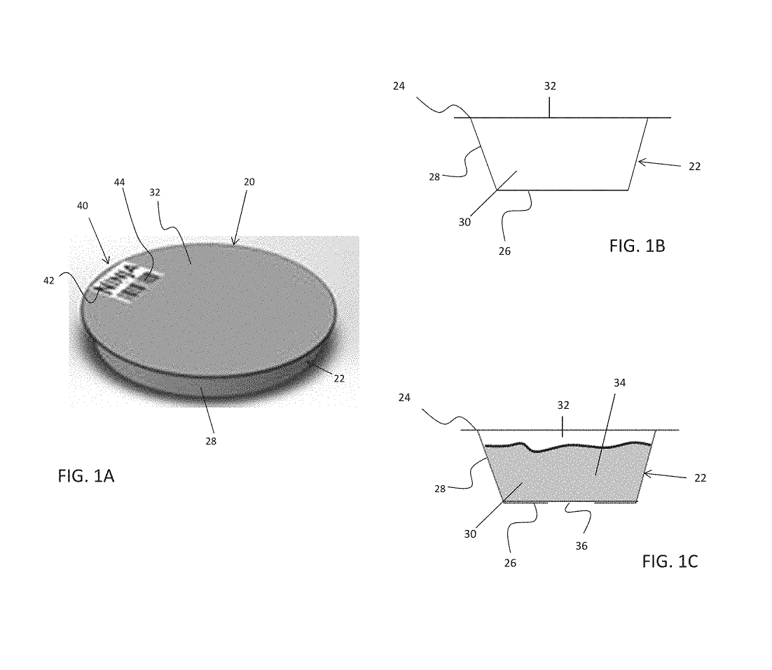

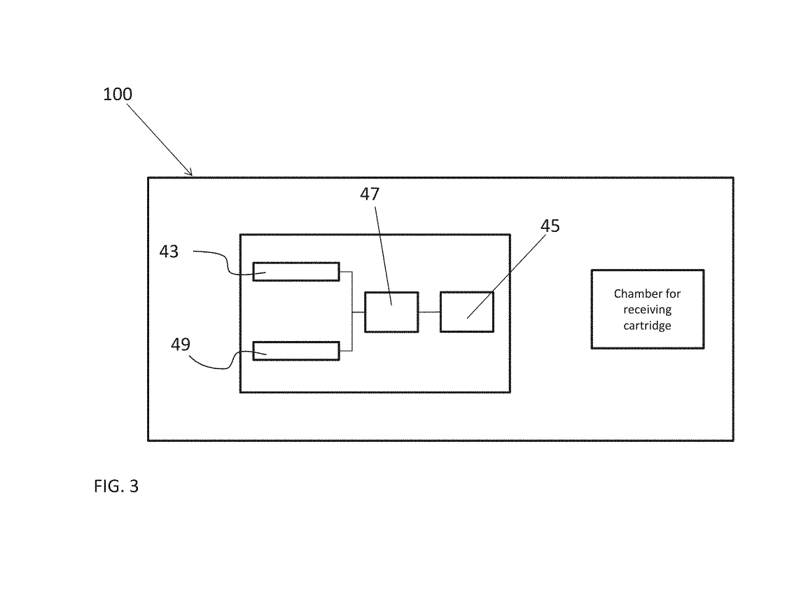

Referring now to the FIGS. 1A-1C, an example of a cartridge 20 for use in preparing a brewed beverage is illustrated. In the context of this disclosure, the term “cartridge” is used to encompass any capsule, pod, sachet, wrapper or other container or case containing a material suitable for use with a beverage brewing system. An example of a beverage brewing system 100 operable to prepare a brewed beverage using a cartridge is known in the art and is illustrated schematically at FIG. 3.

As shown, the cartridge 20 includes a cartridge body 22 having a top 24, a bottom 26, and one or more sidewalls 28 extending there between to define an interior chamber 30. In an embodiment, the cartridge body 22 is formed from a rigid or semi-rigid material, such as plastic for example. In the illustrated, non-limiting embodiment, the cartridge body 22 has a generally frustoconical shape including a circular cross-section. As shown, a diameter of the body 22 adjacent the bottom 26 is smaller than a diameter of the body 22 adjacent the top 24. However, it should be understood that a cartridge 20 having any shape is contemplated herein.

A flexible membrane 32 may be mounted to the top 24 of the cartridge body 22 to seal the chamber 30. In an embodiment, the flexible membrane 32 has a size and shape generally complementary to or slightly larger than the top 24 of the body 22. Depending on the type of beverage brewing system being used to prepare the brewed beverage, the flexible membrane 32 may be removed by the user prior to insertion of the cartridge 20 into a brew chamber of the beverage brewing system 100. Alternatively, the flexible membrane 32 may be pierced by a needle of the beverage brewing system 100 at the time that the cartridge 20 is inserted into the brew chamber of the beverage brewing system 100 at a functional position.

As shown in the cross-sectional view of the cartridge 20 in FIG. 1C, the chamber 30 is at least partially filled with a food product or flavorant 34, such as coffee grinds or tea leaves for example. The flavorant 34 may be loosely arranged within the chamber 30, or alternatively, may be compacted.

During preparation of a beverage using the cartridge 20, the beverage brewing system 100 provides water to the interior of the chamber 30 to wet the flavorant 34 arranged therein. An opening 36 is formed in the bottom of the cartridge body 22 through which the beverage prepared in the cartridge 20 is ejected. In an embodiment, the opening 36 may be formed as a portion of the cartridge body 22. Alternatively, the bottom 26 may be pierced by a needle of the beverage brewing system 100 at the time that the cartridge 20 is inserted into the brew chamber at a functional position. In yet another embodiment, the opening 36 may be transformable from a sealed position to an open position in response to the pressure within the chamber 30. The cartridge 20 illustrated and described herein is intended as an example only, and it should be understood by a person having ordinary skill in the art that any cartridge is within the scope of the disclosure.

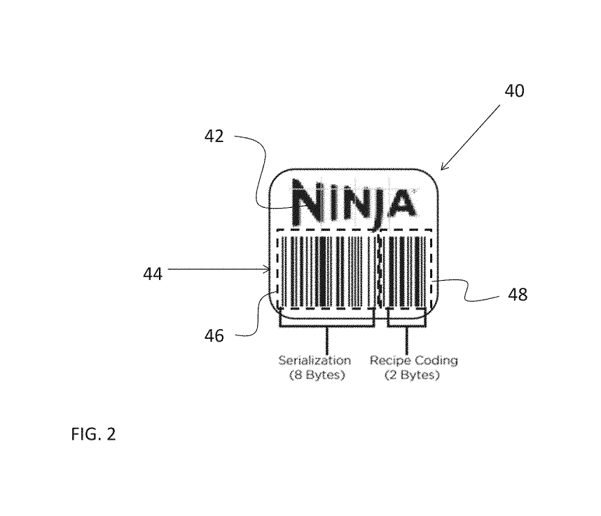

With reference now to FIG. 2, the cartridge 20 is configured to provide information associated with the cartridge 20 to a beverage brewing system 100 when used therewith. To communicate this information, the cartridge 20 includes one or more identification elements 40. The one or more identification elements 40 may be located at any position relative to the cartridge 20. For example, the one or more identification elements 40 may be located on a surface of the flexible membrane 32, as shown in the FIGS., or may be located on the bottom 26 or sidewalk 28 of the cartridge body 20. Further, in embodiments including a plurality of identification elements 40, the plurality of identification elements 40 may be arranged at similar or different locations about the cartridge 20. In addition, the at least one identification element 40 may be integrally formed with a portion of the cartridge 20, such as the flexible membrane 32, or alternatively, may be coupled thereto such as with an adhesive for example.

A first identification element, indicated generally at 42, is configured to provide a first authentication of the cartridge 20 by verifying the manufacturer or brand of the cartridge 20. The first identification element 42 is a contactless identifier comprising data extending in two directions. As shown, the first identification element 42 is a “rastered” graphic or image having a dot matrix data structure representing a grid of pixels. Within the rastered image, each pixel of the grid is coded a specific hue or shade. Collectively, the pixels form an image containing authentication information. In the illustrated, non-limiting embodiment, the rastered graphic includes a logo or trademark associated with the brand of the cartridge 20. For example, in the illustrated, non-limiting embodiment, the rastered image includes the word “Ninja” to identify to at least one of a user and a beverage brewing system 100 that the manufacturer of the cartridge 20 is Shark Ninja Operating LLC. However, it should he understood that any suitable graphic or image may be used.

The first identification element 42 is readable via a scanning device, illustrated schematically at 43, such as a laser scanner operable to emit at least one beam or a camera for example. The scanning device 43 is configured to detect each of the pixels of the image in a known manner and communicate the data to a processor. In an embodiment, the beverage brewing system 100 includes a memory 45 coupled to the processor 47. The data collected from scanning the first identification element 42 may be compared to data stored within the memory 45, or alternatively, may be accessible from a remote database, such as via a communication network, to determine Whether the cartridge 20 is compatible for use with the system. If the processor 47 determines that the manufacturer of the cartridge 20 identified via the first identification element 42 is not compatible for use with the system 100, the system 100 may provide a message or other indication of this to the user.

The cartridge 20 additionally includes a second identification element 44. The second identification element 44 comprises a machine readable code such as barcode for example. In an embodiment, the machine readable code is a one dimensional barcode comprising a plurality of parallel lines of varying widths and spacing. Alternatively, the machine readable code may use rectangles, dots, hexagons and other geometric patterns in two-dimensions. Although a barcode is illustrated and described herein, it should be understood that any suitable contactless identification element is contemplated herein.

The second identification element 44 is readable via a scanning device, illustrated schematically at 49, such as an optical scanner or a barcode reader to detect the information contained therein. In an embodiment, the first identification element 42 and the second identification element 44 may be readable via a single scanning device to reduce the complexity of the beverage brewing system 100. Alternatively, the first identification element 42 may require a first scanning device 43 and the second identification element 44 may require a second scanning device 49, distinct from the first scanning device 43.

In an embodiment, the second identification element 44 includes a distinct first component, illustrated schematically at 46, and a second component, illustrated schematically at 48. The first and second components 46, 48 are configured to communicate different types of information to a beverage brewing system 100. In an embodiment, the first component 46 is arranged at a first end 50 of the second identification element 44 and the second component 48 is arranged at near a second, opposite end 52 of the second identification element 44. In addition, the characters that form the first component 46 and the second component 48 may be similar or may be different.

The first component 46 contains information to provide a second authentication of the cartridge 20. In an embodiment, the first component 46 represents an identification code or number, such as a serial number for example, associated with the cartridge 20. Every cartridge 20 is manufactured with a distinct and unique identification code. The first component 46 comprising an identification code is included to prevent reuse of the cartridge 20, or in embodiments where the second identification element 44 is located on the flexible membrane 32, reuse of the flexible membrane 32 with a different cartridge. In an embodiment, once the identification code has been read by a beverage brewing system 100 and a beverage brewing process associated therewith has been completed, the identification code within the first component 46 of the second identification element 44 is no longer valid. In an embodiment, after preparation of a brewed beverage, the first component 46 of the second identification element 44 is not readable. For example, the beverage brewing system 100 may damage or alter the first component 46. Alternatively, the identification code may be associated with a database accessible by the processor 47, either via inclusion or exclusion therein, to indicate that the cartridge 20 and/or flexible membrane 32 has been previously used.

The second component 48 of the second identification element 44 is associated with one or more parameters of a recipe for preparing a brewed beverage using the cartridge 20. In an embodiment, the second component 48 contains a look up code configured to identify a recipe either stored within the memory of the beverage brewing system 100, or accessible by a processor 47 via a communication link.

In an embodiment, the first identification element 42 and the second identification element 44 are scanned simultaneously. In such embodiments, the information contained within each of the first identification element 42 and the second identification element 44 may be processed sequentially. Alternatively, the first identification element 42 and the second identification element 44 may be scanned or read sequentially. For example, only after reading the first identification element 42 and verifying not only that the cartridge 20 is an authentic to the brand, but also that the brand of cartridge 20 is compatible for use with the beverage brewing system 100, will the second identification element 44 be scanned. The first component 46 and the second component 48 of the second identification element 44 may be scanned either sequentially or at the same time. The information contained in the first component 46 of the second identification element 44 is processed to determine whether or not the identification code contained therein is valid and if the cartridge 20 has been previously used. If the identification code is valid, the information contained within the second component 48 will be processed to access at least one parameter associated with preparation of a beverage using the cartridge 20.

In embodiments where the processor determines that the cartridge 20 is not authentic or that the cartridge 20 is not compatible for use with the beverage brewing system 100, the second identification element 44 may not be read by a scanning device 49 of the beverage brewing system 100. Alternatively, in embodiments where the identification code contained within the first component 46 of the second identification element 44 is not valid or is unreadable, the beverage brewing system 100 will not process the second component to determine the information contained therein.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A cartridge for use with a beverage brewing system to prepare a brewed beverage comprising:
a cartridge body having a chamber;
a flavorant arranged within said chamber;
a first identification element applied to the cartridge, said first identification element providing a first cartridge authenticator; and
a second identification element applied to the cartridge, said second identification element providing a second cartridge authenticator.

2. The cartridge of claim 1, wherein said first identification element and said second identification element are different.

3. The cartridge of claim 1, wherein said first identification element comprises data extending in two directions.

4. The cartridge of claim 1, wherein said first identification element includes a rastered graphic.

5. The cartridge of claim 1, wherein said rastered graphic includes at least one of a logo and trademark associated with a brand of the cartridge.

6. The cartridge of claim 1, wherein said first cartridge authenticator the cartridge includes determining a brand of the cartridge.

7. The cartridge of claim 1, wherein said first cartridge authenticator includes determining whether the cartridge is compatible for use with the beverage brewing system.

8. The cartridge of claim 1, wherein said second identification element includes one of a one dimensional code and a two dimensional code.

9. The cartridge of claim 1, wherein said second identification element includes a barcode.

10. The cartridge of claim 1, wherein said second identification element further comprises:
a first component; and
a second component, distinct from said first component, wherein said first component and said second component contain different types of information.

11. The cartridge of claim 10, wherein said first component includes an identification code.

12. The cartridge of claim 10, wherein said first component is operable to provide said second cartridge authenticator.

13. The cartridge of claim 12, wherein said second cartridge authenticator includes determining whether the cartridge has been used previously.

14. The cartridge of claim 10, wherein said second component is associated with one or more parameters of a recipe for preparing a brewed beverage

15. The cartridge of claim 14, wherein said second component includes a recipe look up code.

16. The cartridge of claim 1, wherein said first identification element and said second identification element are disposed at a first surface of said cartridge body.

17. The cartridge of claim 1, wherein said first identification element is located at a first surface of said cartridge body and said second identification element is arranged at a second surface of said cartridge body, said first surface being different from said second surface.

18. A method of preparing a brewed beverage using a cartridge comprising:
scanning and processing a first identification element to perform a first authentication of the cartridge;
scanning and processing a second identification element to perform a second authentication of the cartridge; and
preparing the brewed beverage in response to said first authentication and said second authentication.

19. The method of claim 18, wherein scanning and processing said first identification element includes determining a brand of the cartridge.

20. The method of claim 18, wherein scanning and processing said first identification element includes determining whether the cartridge is compatible for use with the beverage brewing system.

21. The method of claim 18, wherein scanning and processing said second identification element further comprises:
scanning and processing a first component of said second identification element to perform said second authentication; and
scanning and processing a second component of said second identification element to determine one or more parameters for preparing the brewed beverage.

22. The method of claim 21, wherein scanning and processing said first component of second identification element includes determining whether the cartridge has been used previously.

23. The method of claim 21, wherein scanning and processing said second component of second identification element includes identifying a recipe look up code associated with the cartridge.
